(19) United States
(12) Patent Application Publication
(10) Pub. No.: US 2006/0234682 A1
(43) Pub. Date: Oct. 19, 2006

(54) Method and apparatus for locating wireless access points

(75) Inventors: Paul L. Dent, Austin, TX (US); Bobby Sams, Austin, TX (US); Jon Harris, Little Elm, TX (US); Jon Paden, Austin, TX (US); Robert Smith, Cedar Park, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/095,395

(22) Filed: Mar. 31, 2005

(51) Int. Cl. H04M 11/10

(52) U.S. Cl. 455/413

(57) ABSTRACT

A wireless access point locator (108) operating as an interactive voice response (UVR) system has a memory (108B), and a processor (108A). The processor is programmed to locate (204) one or more wireless access points in response to a request from a calling party (102), and submit (212) to the calling party one or more locations corresponding to one or more wireless access points found in the locating step.

### FIELD OF THE INVENTION

This invention relates generally to location technologies, and more particularly to a method and apparatus for locating wireless access points.

### BACKGROUND OF THE INVENTION

Short-range wireless networking such as IEEE 802.11a/b/g is quickly becoming the medium of choice for consumers who want access to the Internet in public places. Network providers provide wireless Internet access by way of a conventional wireless access point located in public places such as airports, restaurants, libraries, or other public locations.

Typically, network providers assist customers in finding locations of wireless access points by making location information available on the Internet by way of an Internet browser such as Microsoft's Internet Explorer. However, access to the Internet is not always readily available especially for customers who travel, and who do not have Internet browser capable mobile phones.

### SUMMARY OF THE INVENTION

Embodiments in accordance with the invention provide a method and apparatus for locating wireless access points.

In a first embodiment of the present invention, a computer-readable storage medium operating as an interactive voice response (IVR) system is accessible by a calling party over a communication system. The storage medium has computer instructions for locating one or more wireless access points in response to a request from a calling party, and submitting to the calling party one or more locations corresponding to one or more wireless access points found in the locating step.

In a second embodiment of the present invention, a wireless access point locator (WAPL) operating as an IVR system has a memory, and a processor coupled to the memory. The processor is programmed to locate one or more wireless access points in response to a request from a calling party, and submit to the calling party one or more locations corresponding to one or more wireless access points found in the locating step.

In a third embodiment of the present invention, an IVR system operates according to a method having the steps of locating one or more wireless access points in response to a request from a calling party, and submitting to the calling party one or more locations corresponding to one or more wireless access points found in the locating step.

### BRIEF DESCRIPTION OF THE DRAWINGS

FIG. 1 is block diagram of a wireless access point locator (WAPL) operating as an interactive voice response (IVR) system in a communication system according to an embodiment of the present invention; and

FIG. 2 depicts a flow chart of a method operating in the WAPL according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

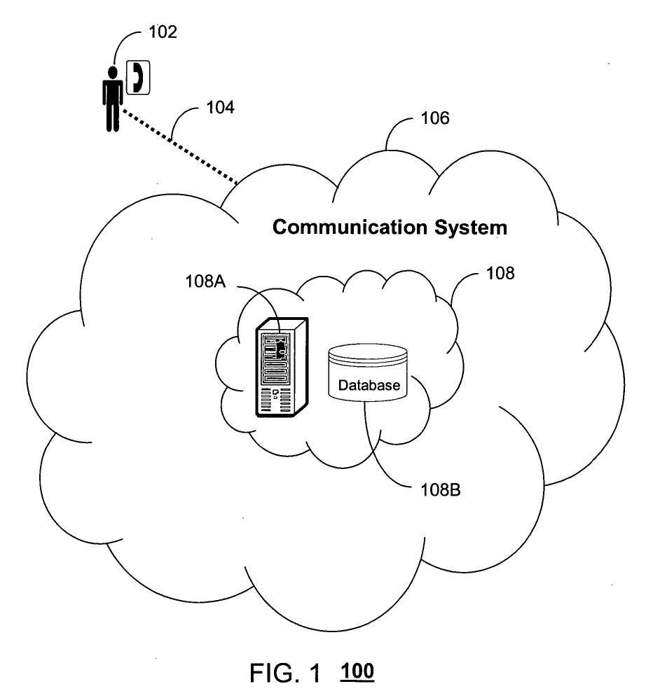

FIG. 1 is block diagram of a wireless access point locator (WAPL) 108 operating as an interactive voice response (IVR) system in a communication system 106 according to an embodiment of the present invention. The WAPL 108 utilizes conventional technology such as a processor 108A and a memory 108B. The processor 108A can utilize a conventional computer or server. The memory 108B can utilize a conventional media device (such as a high capacity disk drive) for storage purposes and is used in the present application as a database for managing the location of wireless access points. Although the processor 108A and memory 108B are shown separately, they can be in the alternative an integral unit. The WAPL 108 is coupled to a conventional communication system 106. As such a calling party 102 can communicate with the WAPL 108 by way of conventional communication lines 104 such as wire line or wireless services of the communication system 106.

Accordingly, the communication system 106 can be a hybrid of wire line and wireless technology providing a calling party access to the WAPL 108 in any geographic location covered by said system 106. The WAPL 108 operates as an IVR (Interactive Voice Response) system utilizing conventional voice recognition technology and text-to-speech technology for exchanging messages with the calling party 102. Additionally, the WAPL 108 can send data messages to a portable device of the calling party 102 as will be explained shortly.

In the present context a wireless access point can be represented by a WLAN (Wireless Local Area Network) that provides short-range wireless communications such as defined by IEEE 802.11a/b/g (incorporated herein by reference). It will be appreciated, however, that a wireless access point can refer to any present and future short to mid-range wireless communication technology (e.g., Bluetooth) accessible to the public.

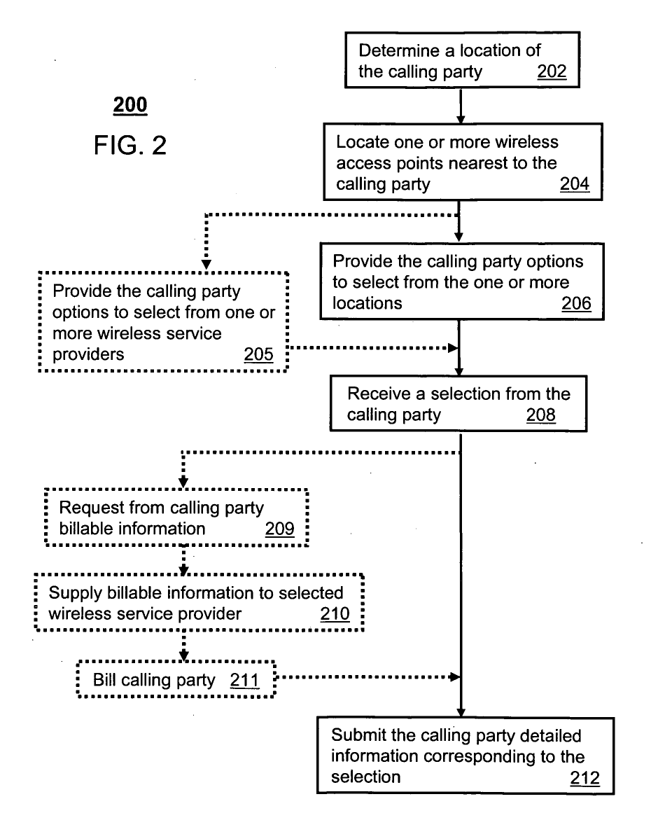

FIG. 2 depicts a flow chart of a method 200 operating in the WAPL 108 according to an embodiment of the present invention. Method 200 begins with step 202 where the WAPL 108 determines a location of the calling party 102. Said calling party 102 can be located according to a number of embodiments including, but not limited to, an originating phone number of the calling party, a location provided by a wireless device of the calling party, a zip code entered by the calling party, or a voice message provided by the calling party. In the first case, the originating phone number provides an area code and exchange. If the calling party is calling from a wire line phone, then the originating phone number can be used to determine the approximate location of the calling party 102. If, however, the calling party 102 is communicating with a mobile phone, said number may not accurately locate the calling party 102. In this instance, the WAPL 108 can ask the calling party 102 his or her location inclusive of the function of step 202 to compare with the location derived from the originating phone number.

Alternatively, the WAPL 108 can always ask the calling party 102 in step 202 to verbally provide his/her location. In yet another embodiment, if the calling party 102 has a GPS (Global Positioning System) enabled mobile phone, the WAPL 108 can request a location fix from said device. It would be evident by one of ordinary skill in the art that any method for locating the calling party 102 can be applied to step 202 as contemplated by the scope and spirit of the claims described herein.

Once a location of the calling party 102 has been determined, in step 204 the WAPL 108 upon the request of the calling party locates in the database 108B one or more wireless access points nearest to the location of the calling party 102. The wireless access points can be located in retail stores, restaurants, an airport, or other publicly accessible area. The information contained in the database 108B is managed and updated by the service provider of the WAPL 108. In step 206, the calling party 102 is provided options to select from the one or more locations of wireless access points found in step 204. Alternatively, the calling party 102 can be provided in step 205 options to select from one or more wireless service providers each providing wireless access point services at a various locations near the calling party 102.

The above options can be selected by way of DTMF (Dual Tone Multi-Frequency) depressions on a conventional mobile or fixed phone coupled to the communication system 102, and/or speech interactions between the calling party 102 and the WAPL 108 on said phone. For example, the WAPL 108 can convey a speech message to the calling party 102 indicating three locations for wireless access point service. The calling party 102 can, for example, verbally (or using DTMF depressions) request the WAPL 108 to convey the general area of the first location by way of synthesized speech. The calling party 102 can then choose to ask the WAPL 108 for the next location, or make his selection at that point. The interactions between the calling party 102 and the WAPL 108 can be designed to be as comprehensive as needed to satisfy the needs of the calling party 102.

In step 208, the WAPL 108 receives a selection from the calling party 102. In the case where the calling party 102 selects a wireless service provider, the WAPL 108 proceeds to steps 209 through 211. In step 209, the WAPL 108 requests from the calling party 102 billable information such as a credit card number, name on the credit card, and expiration date. In step 210, the WAPL 108 supplies the billable information provided by the calling party 102 to the wireless service provider for validation. Once credit card has been validated, in step 210 the calling party 102 is billed and the WAPL 108 proceeds to step 212. Alternatively, the calling party 102 may have chosen in step 206 a wireless access point available at one or more public places where patrons are provided wireless access point service free of charge. In this embodiment, the WAPL 108 proceeds from step 208 to step 212.

In step 212, the calling party 102 is provided detailed information corresponding to the selected location of the wireless access point. This step can be performed either through a synthesized text to speech message, or by transmitting a data message to a portable wireless device (e.g., a mobile phone) of the calling party. In the former case, the speech message provides, for example, a detailed address, and possibly directions, specific parameters of the wireless access point such as login, password, and/or the encryption method to be used. In the latter case, the data message can be a conventional SMS (Short Message Service) including the information mentioned above. Said SMS message is transmitted by conventional means to a mobile phone of the calling party 102. In the case where the calling party 102 has a GPS-enabled mobile phone, the SMS message can include a location coordinate (e.g., longitude plus latitude), thereby providing the calling party 102 a means to navigate to the selected location of the wireless access point.

It should be evident by now that the present invention can be realized in hardware, software, or a combination of hardware and software. Moreover, the present invention can be realized in a centralized fashion, or in a distributed fashion where different elements are spread across several interconnected processors. Any kind of computer device or other apparatus adapted for carrying out method 300 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. For example, method 200 can be reduced to two steps (204 and 212). In this embodiment, the request provided by the calling party 102 in step 204 may be informative enough for the WAPL 108 to search its database for one or more wireless access points, and provide details to said locations in step 212. This is but one of many embodiments that can be derived by modifying method 200. It would be clear therefore to those skilled in the art that modifications to the disclosed embodiments described herein could be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium operating as an interactive voice response (IVR) system accessible by a calling party over a communication system, the storage medium comprising computer instructions for:
locating one or more wireless access points in response to a request from a calling party; and
submitting to the calling party one or more locations corresponding to one or more wireless access points found in the locating step.

2. The storage medium of claim 1, wherein the submitting step further comprises computer instructions for:
providing the calling party options to select from the one or more locations;
receiving a selection from the calling party; and
submitting the calling party detailed information corresponding to the selection made by the calling party.

3. The storage medium of claim 2, wherein information exchanged in the providing, receiving and submitting steps comprises voice messages and data messages.

4. The storage medium of claim 2, wherein the submitting step comprises transmitting to a wireless device of the calling party a wireless message comprising the detailed information.

5. The storage medium of claim 1, further comprising computer instructions for:
determining a location of the calling party; and
wherein the locating step comprising computer instructions for locating one or more wireless access points nearest to the location of the calling party.

6. The storage medium of claim 5, wherein the determining step further comprises computer instructions for locating the calling party according to one among a group of sources comprising an originating phone number of the calling party, a location provided by a wireless device of the calling party, a zip code entered by the calling party, and a voice message provided by the calling party representing the location of the calling party.

7. The storage medium of claim 1, wherein the one or more access points correspond to one or more wireless service providers, and wherein the storage medium further comprises computer instructions for:
providing the calling party options to select from at least one among the one or more wireless service providers;
receiving a selection from the calling party; and
submitting the calling party detailed information of the selected wireless service provider.

8. The storage medium of claim 7, further comprising computer instructions for:
requesting from the calling party billable information;
supplying the billable information to the selected wireless service provider for validation; and
billing the calling party upon validation.

9. The storage medium of claim 1, wherein the locating step comprises computer instructions for searching a database for the one or more wireless access points according to the request supplied by the calling party.

10. A wireless access point locator (WAPL) operating as an IVR system, comprising:
a memory; and
a processor coupled to the memory, wherein the processor is programmed to:
locate one or more wireless access points in response to a request from a calling party; and
submit to the calling party one or more locations corresponding to one or more wireless access points found in the locating step.

11. The WAPL of claim 10, wherein the submit step the processor is further programmed to:
provide the calling party options to select from the one or more locations;
receive a selection from the calling party; and
submit the calling party detailed information corresponding to the selection made by the calling party.

12. The WAPL of claim 11, wherein information exchanged in the provide, receive and submit steps comprises voice messages and data messages.

13. The WAPL of claim 11, wherein the submit step the processor is further programmed to transmit to a wireless device of the calling party a wireless message comprising the detailed information.

14. The WAPL of claim 10, wherein the processor is further programmed to:
determine a location of the calling party; and
wherein the locate wherein the processor is programmed to locate one or more wireless access points nearest to the location of the calling party.

15. The WAPL of claim 14, wherein the determine step the processor is further programmed to locate the calling party according to one among a group of sources comprising an originating phone number of the calling party, a location provided by a wireless device of the calling party, a zip code entered by the calling party, and a voice message provided by the calling party representing the location of the calling party.

16. The WAPL of claim 10, wherein the one or more access points correspond to one or more wireless service providers, and wherein the processor is further programmed to:
provide the calling party options to select from at least one among the one or more wireless service providers;
receive a selection from the calling party; and
submit the calling party detailed information of the selected wireless service provider.

17. The WAPL of claim 16, wherein the processor is further programmed to:
request from the calling party billable information;
supply the billable information to the selected wireless service provider for validation; and
bill the calling party upon validation.

18. The WAPL of claim 10, wherein the locate step the processor is programmed to search a database for the one or more wireless access points according to the request supplied by the calling party.

19. In an interactive voice response (IVR) system, a method comprising the steps of:
locating one or more wireless access points in response to a request from a calling party; and
submitting to the calling party one or more locations corresponding to one or more wireless access points found in the locating step.

20. The method of claim 19, wherein the locating step comprises the step of searching a database for the one or more wireless access points according to the request supplied by the calling party, and wherein the submitting step further comprises steps of:
providing the calling party options to select from the one or more locations;
receiving a selection from the calling party; and
submitting the calling party detailed information corresponding to the selection made by the calling party.
